(19) United States
(12) Patent Application Publication
(10) Pub. No.: US 2026/0275907 A1
(43) Pub. Date: Sep. 17, 2026

(54) SYSTEMS AND APPARATUS TO LUBRICATE A GAS TURBINE ENGINE VIA AN EXTERNAL PRESSURE SOURCE

(71) Applicant: General Electric Company, Evendale, OH (US)

(72) Inventors: Thomas Bradley Kenney, Marblehead, MA (US); James Luz, Tewksbury, MA (US); Jonathan K. Remer, Saugus, MA (US); Samair Alyassini, Pittsboro, NC (US)

(73) Assignee: General Electric Company, Evendale, OH (US)

(21) Appl. No.: 19/253,191

(22) Filed: Jun. 27, 2025

Related U.S. Application Data
(60) Provisional application No. 63/687,606, filed on Aug. 27, 2024.

(51) Int. Cl. F02C 7/06; F02C 7/14

(52) U.S. Cl. CPC F02C 7/06; F02C 7/14; F05D 2260/606; F05D 2260/98

(57) ABSTRACT

Systems, apparatus, articles of manufacture, and methods are disclosed for lubricating a gas turbine comprising: a reservoir configured to store a lubricant; a supply pump configured to pump the lubricant from the reservoir to a component of the gas turbine engine via a supply conduit; a scavenge pump configured to pump the lubricant from the component; and a valve fluidly coupled with the scavenge pump, the valve to control a flow of the lubricant to the reservoir; and an external pressure source coupled with the valve, the external pressure source to provide a pressure to actuate the valve from a supply position to a bypass position, wherein in the bypass position the valve fluidly couples the lubricant flowing through the scavenge pump into a bypass conduit, the bypass conduit extending from the valve to a location downstream of the supply pump.

### RELATED APPLICATION

This patent claims the benefit of U.S. Provisional Patent Application No. 63/687,606, which was filed on Aug. 27, 2024. U.S. Provisional Patent Application No. 63/687,606 is hereby incorporated herein by reference in its entirety. Priority to U.S. Provisional Patent Application No. 63/687,606 is hereby claimed.

### GOVERNMENT INTEREST

This invention was made with Government support under contract No. W58RGZ-16-C-0047 awarded by the Department of Defense (DOD). The Government has certain rights in this invention.

### FIELD OF THE DISCLOSURE

This disclosure relates generally to gas turbine engines and, more particularly, to systems and apparatus to lubricate a gas turbine engine.

### BACKGROUND

Gas turbine engines generally include a compressor section, a combustion section, and a turbine section. During operation, the compressor section progressively increases the pressure of air entering the engine and supplies compressed air to the combustion section. The compressed air and fuel mix within the combustion section and burn within a combustion chamber to generate high-pressure and high-temperature combustion gases. The combustion gases flow through a hot gas path defined by the turbine section before exiting the engine. The turbine section converts energy from the combustion gases into rotational energy. Specifically, the turbine section includes a plurality of rotor blades that rotate using the kinetic energy and/or thermal energy generated from the combustion gases. The extracted rotational energy is, in turn, used to rotate one or more shafts, thereby driving the compressor section and/or a fan assembly of the gas turbine engine.

Gas turbine engines include a lubricant system (e.g., a recirculation system, a lubricant system, a coolant system, a lubricant and a coolant system, etc.) to supply a lubricant and/or a coolant (e.g., oil, grease, etc.) (as used herein “lubricant”) to one or more components of the turbine engine. The lubrication system includes a supply conduit fluidly connected to a supply pump that pumps lubricant from a reservoir via the supply conduit to a target component. In some examples, the lubricant can be pumped through various components of the engine (e.g., a deicing circuit, etc.) before reaching the target component. Furthermore, the lubrication system includes a scavenge conduit fluidly connected to a scavenge pump that pumps lubricant from the target component back to the reservoir.

### BRIEF DESCRIPTION OF THE DRAWINGS

FIG. 1 is a cross-sectional view of an example gas turbine engine.

FIG. 2 is a schematic view of an example apparatus to lubricate the gas turbine engine of FIG. 1 including an external pressure source.

FIG. 3A is a schematic view of the example valve, the example spool, and the example external pressure source of FIG. 2.

FIG. 3B is another schematic view of the example valve, the example spool, the example external pressure source of FIG. 2.

FIG. 3C is another schematic view of the example valve and the example external pressure source of FIG. 2.

FIG. 3D is another schematic view of the example valve and the example external pressure source of FIG. 2.

FIG. 4 is another schematic view of an example apparatus to lubricate a gas turbine engine including the external pressure source of FIG. 2.

FIG. 5 is a block diagram of an example implementation of the external pressure source of FIG. 2.

FIG. 6 is a flowchart of an example method of operation of the example apparatus of FIGS. 2-4.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “forward” refers to an area of the gas turbine engine where air enters the engine (e.g., the “cold end” of the gas turbine engine). The forward area can include the compressor of the gas turbine engine.

As used herein, “aft” refers to an area of the gas turbine engine where air exits the engine (e.g., the “hot end” of the gas turbine engine). The aft area of the gas turbine engine can include the combustion chamber, the turbine section, and/or the exhaust.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

The gas turbine engine of the present disclosure is configured to supply a lubricant (e.g., oil) from a reservoir to one or more components (e.g., a sump(s), a gearbox(es), etc.) of the gas turbine engine. In some examples, the system includes a supply conduit extending from the reservoir to the one or more components of the engine. As used herein, the “supply conduit” provides a flow of the lubricant from the reservoir, a supply pump, and/or another source of lubricant to the one or more components of the engine. The system also includes a supply pump configured to pump the lubricant from the reservoir through the supply conduit. As used herein, the “supply pump” pumps lubricant from the reservoir to the one or more components of the engine and/or a valve of the engine via the supply conduit to lubricate the one or components of the engine. Moreover, in some examples, the system includes an outer body deicing circuit fluidly coupled in series with the supply conduit. In these examples, the lubricant within the supply conduit flows through the deicing circuit before reaching the one or more components. Additionally, the system includes a scavenge conduit extending from the one or more components to the reservoir and a scavenge pump(s) configured to pump lubricant from the one or more components through the scavenge conduit. As used herein, the “scavenge conduit” recirculates the lubricant from the one or more components and routes the lubricant to the reservoir and/or the scavenge pump(s). As used herein, the “scavenge pump(s)” pumps the recirculated lubricant from the one or more components to the valve for recirculation through the system.

Further, the system includes a valve and a bypass conduit. The valve is fluidly coupled in series with the supply and scavenge conduits. The bypass conduit extends from the valve to a location on the supply conduit downstream of the outer body deicing circuit and/or downstream of the supply pump. During normal operation of the system, the valve is in a supply position. In the supply position, the valve fluidly couples the supply conduit to the one or more components. Accordingly, the supply pump pumps lubricant from the reservoir through the valve to a component of the turbine engine. In some examples, during normal operation of the system, the supply pump pumps the lubricant from the reservoir through the valve and deicing circuit to the one or more components of the turbine engine. During normal operation of the system, the valve directs the lubricant flowing through the scavenge conduit (e.g., the lubricant returning from the component) into the reservoir.

In some instances, the flow of the lubricant from the reservoir through the valve via the supply conduit can be interrupted or otherwise halted. Such an interruption can be caused by damage to the reservoir and/or the deicing circuit, or by the performance of an aerial maneuver. In such instances, the valve switches to a bypass position to direct the lubricant flowing through the scavenge conduit into the bypass conduit. In the bypass position, the lubricant flows through the bypass conduit before reentering the supply conduit for delivery to the one or more components.

In these examples, the valve switches from the supply position to the bypass position via pressure from an external pressure source. The external pressure source can be located in a part of the turbine engine that is not damaged when the reservoir is damaged (e.g., in a location removed from the reservoir, etc.). As used herein, the external pressure source is defined as any pressure source that is not entirely contained in the valve. The pressure source may be located in an alternate part of the engine or outside of the engine. In some examples, the external pressure source provides a constant pressure to actuate the valve from the supply position to the bypass position. The external pressure source can provide the pressure constantly (e.g., at all times regardless of flow interruption from the supply pump) or be triggered upon a threshold drop of discharge pressure from a supply pump of the reservoir. As used herein, pressure provided constantly by the external pressure source refers to pressure while the engine is in operation, while the engine is operating in a certain phase, and/or while the engine is operating in a certain mode. Further, in some examples, the external pressure source can cease to provide pressure after the discharge pressure from the supply pump of the reservoir exceeds a threshold value (e.g., after completion of an aerial maneuver, etc.).

In other examples, the valve can be positioned within the system such that the valve is unable to control the flow of the lubricant through the supply conduit. In such examples, the valve can be fluidly actuated by the flow of lubricant through the supply conduit. For example, a fluid passageway can extend from the supply conduit to the valve such that the fluid within the fluid passage actuates the valve. In some examples, the fluid passageway connects in parallel with the external pressure source so that the external pressure source can actuate and/or contribute to actuating the valve. In these examples, the bypass conduit extends from the valve to a position downstream of the supply pump (as the outer body deicing circuit may not be present in such examples).

The valve, the bypass circuit, and the external pressure source provide a fallback system for lubrication of the turbine engine. Particularly, damage to the reservoir and/or the deicing circuit can cause the lubricant being returned to the reservoir and/or supplied to the deicing circuit to leak out of the system. When flow is interrupted in conventional lubrication systems, the one or more components may not receive sufficient lubricant, which can result in damage to the one or more components. Furthermore, in conventional lubrication systems, aerial maneuvers can cause the lubricant within the reservoir to flow to one side, which temporarily interrupts the flow of the lubricant to the one or more components. Particularly, aircraft with a single engine fixed-wing configuration and/or rotorcrafts struggle to accommodate a loss of oil supply midflight.

However, in such instances, the valve and the bypass circuit of the disclosed system direct lubricant flowing through the scavenge conduit back into the supply conduit, bypassing the reservoir and/or deicing circuit. As such, the flow of lubricant to the one or more components is maintained after damage and/or interruption of flow to the reservoir and/or deicing circuit. Further, the external pressure source ensures that constant flow is maintained regardless of the pressure of the lubricant in the supply conduit. Therefore, in instances of decreased flow or variable flow from the supply conduit to the valve, the valve actuates to the bypass position via the pressure from the external pressure source to ensure the lubricant reaches the one or more components.

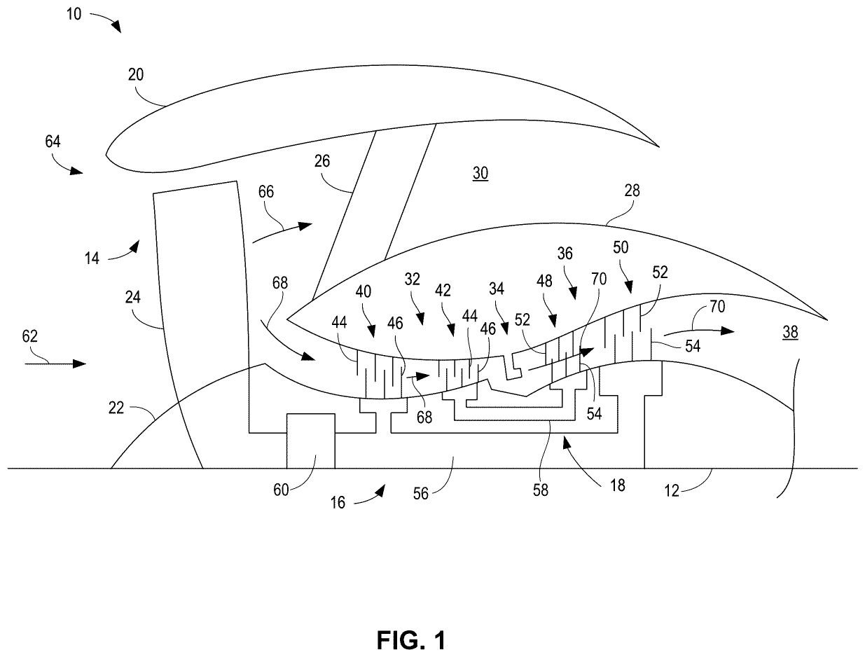

FIG. 1 is a schematic cross-sectional view of an example gas turbine engine 10. In the illustrated example of FIG. 1, the engine 10 is configured as a high-bypass turbofan engine. In other examples, the engine 10 can be a propfan engine, a turbojet engine, a turboprop engine, a turboshaft engine, or any other suitable type of gas turbine engine.

In general, the engine 10 includes a fan 14, a low-pressure (LP) spool 16, and a high-pressure (HP) spool 18 at least partially encased by an annular nacelle 20. The fan 14 can include a fan rotor 22 and a plurality of fan blades 24 coupled to the fan rotor 22. In the illustrated example of FIG. 1, one of the plurality of fan blades 24 can be seen. However, from other perspectives, more than one of the plurality of fan blades 24 can be seen. The plurality of fan blades 24 are circumferentially spaced from each other and extend outward from the fan rotor 22. Moreover, the LP spool 16 and HP spool 18 are positioned downstream from the fan 14 along an axial centerline 12. The LP spool 16 is rotatably coupled to the fan rotor 22 and rotates the fan 14. Additionally, a plurality of outlet guide vanes or struts 26 circumferentially spaced from each other extend between an outer casing 28 surrounding the LP spool 16, HP spool 18, and the nacelle 20.

The outer casing 28 (e.g., outer body) generally surrounds or encases, in serial flow order, a compressor section 32, a combustion section 34, a turbine section 36, and an exhaust section 38. In some examples, the compressor section 32 can include a low-pressure (LP) compressor 40 of the LP spool 16, and a high-pressure (HP) compressor 42 of the HP spool 18 positioned downstream from the LP compressor 40 along the axial centerline 12. The LP compressor 40 and the HP compressor 42 can include one or more rows of stator vanes 44 interdigitated with one or more rows of compressor rotor blades 46. Further, the turbine section 36 can include a high-pressure (HP) turbine 48 of the HP spool 18, and a low-pressure (LP) turbine 50 of the LP spool 16 positioned downstream from the HP turbine 48 along the axial centerline 12. The HP turbine 48 and the LP turbine 50 can include one or more rows of stator vanes 52 interdigitated with one or more rows of turbine rotor blades 54.

The LP spool 16 includes the low-pressure (LP) shaft 56, and the HP spool 18 includes a high-pressure (HP) shaft 58 positioned concentrically around the LP shaft 56. In this example, the HP shaft 58 rotatably couples the rotor blades 54 of the HP turbine 48 and the rotor blades 46 of the HP compressor 42. In turn, the turbine rotor blades 54 rotatably drive the compressor rotor blades 46. In the illustrated example of FIG. 1, the LP shaft 56 is directly coupled to the turbine rotor blades 54 of the LP turbine 50 and the compressor rotor blades 46 of the LP compressor 40. Further, the LP shaft 56 is coupled to the fan 14 via a gearbox 60. Accordingly, the rotation of the LP turbine rotor blades 54 rotatably drives the LP compressor rotor blades 46 and the plurality of fan blades 24.

In some examples, the engine 10 can generate thrust to propel an aircraft. More specifically, during operation, air (indicated by an arrow 62) enters an inlet portion 64 of the engine 10. The fan 14 supplies a first portion (indicated by an arrow 66) of the air 62 to a bypass airflow passage 30 and a second portion (indicated by an arrow 68) of the air 62 to the compressor section 32. The second portion of the air 62 first flows through the LP compressor 40 in which the compressor rotor blades 46 therein progressively compress the second portion 68 of the air 62. After compression by the LP compressor 40, the second portion 68 of the air 62 flows through the HP compressor 42 in which the compressor rotor blades 46 therein continue progressively compressing the second portion 68 of the air 62. The compressed second portion 68 of the air 62 is subsequently delivered to the combustion section 34. In the combustion section 34, the second portion 68 of the air 62 mixes with fuel and burns to generate high-temperature and high-pressure combustion gases 70. After the generation of high-temperature and high-pressure combustion gases 70, the combustion gases 70 flow through the HP turbine 48. The HP turbine rotor blades 54 extract a first portion of kinetic and/or thermal energy from the combustion gases 70. The extraction of the first portion of kinetic and/or thermal energy rotates the HP shaft 58 and drives the HP compressor 42. The combustion gases 70 flow through the LP turbine 50 where the LP turbine rotor blades 54 extract a second portion of kinetic and/or thermal energy from the combustion gases 70. The extraction of a second portion of kinetic and/or thermal energy rotates the LP shaft 56 and drives the LP compressor 40 and the fan 14 via the gearbox 60. The combustion gases 70 then exit the engine 10 through the exhaust section 38.

The configuration of the gas turbine engine 10 of FIG. 1 is only one example. Accordingly, the disclosed subject matter can be adapted to any manner of gas turbine engine configuration, including other types of aviation-based gas turbine engines, marine-based gas turbine engines, and/or land-based/industrial gas turbine engines.

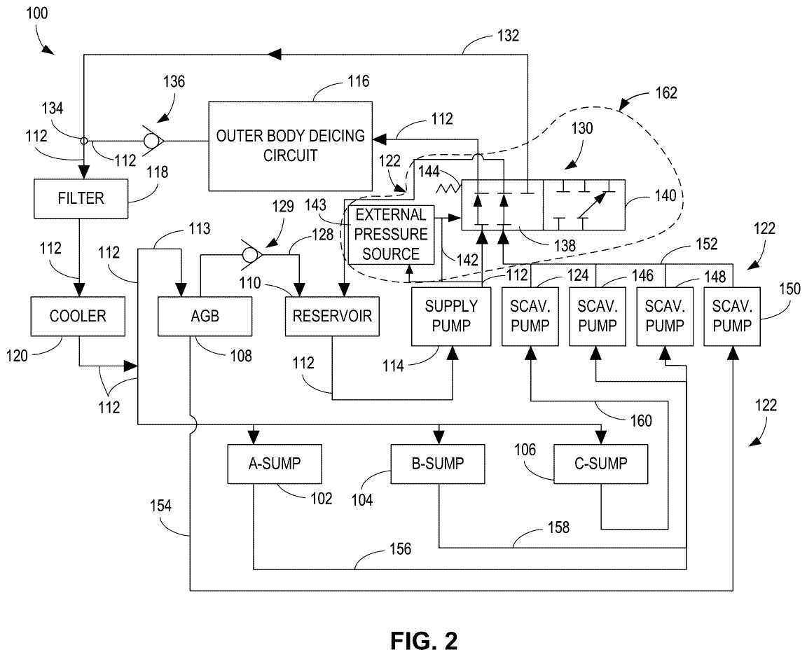

FIG. 2 is an example of a system 100 for lubricating the one or more components of the gas turbine engine 10 (FIG. 1). In the illustrated example of FIG. 2, the system 100 is discussed in the context of the gas turbine engine 10. However, the system 100 can be implemented in any gas turbine engine 10 with any other suitable configuration.

In some examples, the system 100 can provide the lubricant to one or more components of the gas turbine engine 10. In the illustrated examples of FIG. 2, the system 100 provides the lubricant to a first sump 102 (e.g., A-sump), a second sump 104 (e.g., B-sump), and a third sump 106 (e.g., C-sump) of the engine 10. The first sump 102 can house one or more bearings that rotatably support the forward end of the LP shaft 56 of FIG. 1. Further, the second sump 104 can house one or more bearings that rotatably support the HP shaft 58 of FIG. 1. Further, the third sump 106 can house one or more bearings that rotatably support the aft end of the LP shaft 56 of FIG. 1. Additionally, the system 100 can provide the lubricant to an accessory gearbox (AGB) 108 of the engine. The AGB 108 transmits power from the HP shaft 58 to one or more pumps or other accessory components of the engine 10. In other examples, the system 100 can lubricate any other suitable components of the gas turbine engine 10, such as other sumps, gearboxes (the gearbox 60), and/or any other components.

Further, the system 100 can be configured to supply a lubricant to the one or more components of the gas turbine engine 10. In some examples, the lubricant can be oil, grease, synthetic, and/or other lubricant that prevents wear and reduces friction between the components of the engine.

The system 100 includes a reservoir 110, a supply conduit 112, and a supply pump 114. In particular, the reservoir 110 is configured to store the lubricant. The supply conduit 112 extends from the reservoir 110 to the one or more components. In the illustrated example of FIG. 2, the supply conduit 112 extends from the reservoir 110 to the first sump 102, the second sump 104, and the third sump 106. The first sump 102, the second sump 104, and the third sump 106 are fluidly coupled in parallel to each other. In some examples, the AGB 108 is fluidly coupled to the supply conduit 112 in parallel with the sumps 102, 104, 106 via a branch 113. In one example, the branch 113 can be located within the AGB 108. In these examples, a portion of the lubricant within the supply conduit 112 flows to the AGB 108 and another portion of the lubricant within the supply conduit 112 flows to the sumps 102, 104, 106. Further, the supply pump 114 is fluidly coupled in series with the supply conduit 112 upstream from the AGB 108. The supply pump 114 is configured to pressurize or otherwise pump lubricant stored within the reservoir 110 through the supply conduit 112 such that the lubricant is supplied to the AGB 108 and the sumps 102, 104, 106. The supply pump 114 pumps the lubricant to the components at a discharge pressure. As used herein, “discharge pressure” refers to the pressure of lubricant exiting the supply pump 114. In one example, the supply pump 114 is driven via the AGB 108. However, in other examples, the supply pump 114 can be driven by an external power source, by an internal motor of the supply pump 114, etc.

Further, the system 100 includes an outer body deicing circuit 116. The deicing circuit 116 is configured to heat a portion of the outer casing 28 to remove ice and/or other accumulated frozen substance. The deicing circuit 116 is fluidly coupled in series with the supply conduit 112 such that the lubricant flows through the deicing circuit 116 before reaching the AGB 108 and the sumps 102, 104, 106. In particular, the deicing circuit 116 corresponds to a series of passages, tubes, and/or other conduits positioned adjacent to the outer casing 28 (FIG. 1) of the engine 10. In some examples, the flow of the lubricant through the deicing circuit 116 heats the outer casing 28.

Other component(s) can be operatively coupled with the supply conduit 112. In some examples, a lubricant filter 118 is fluidly coupled to the supply conduit 112 downstream of the supply pump 114 and upstream of the AGB 108. The lubricant filter 118 is configured to remove particulates and other contaminants present within the lubricant flowing through the supply conduit 112.

In some examples, a lubricant cooler 120 is fluidly coupled to the supply conduit 112 downstream of the supply pump 114 and the lubricant filter 118, and upstream of the AGB 108 and the sumps 102, 104, 106. Further, the lubricant cooler 120 is configured to cool the lubricant flowing through the supply conduit 112 before the lubricant reaches the AGB 108 and the sumps 102, 104, 106. In some examples, the lubricant cooler 120 is configured to transfer heat from the lubricant to any other suitable fluid supporting the operation of the engine 10.

Further, one or more sensors, indicators, or any other suitable component can be operatively coupled to the supply conduit 112.

In the illustrated example of FIG. 2, the system 100 includes a scavenge circuit 122 comprising multiple scavenge system conduits and one or more scavenge pumps 124, 146, 148, 150. The scavenge circuit 122 extends from a component (e.g., a lubricated component, etc.) to the reservoir 110. As shown, the scavenge circuit 122 extends from the first sump 102, the second sump 104, and the third sump 106, and the AGB 108 to the reservoir 110. Further, in the example of FIG. 2, the scavenge circuit 122 includes a bulk scavenge conduit 152 and branches 154, 156, 158, 160 that are fluidly coupled to the bulk scavenge conduit 152 via multiple scavenge pumps 124, 146, 148, 150. In particular, a first branch 154 extends from the AGB 108 to the bulk scavenge conduit 152. A second branch 156 extends from the first sump 102 to the bulk scavenge conduit 152. A third branch 158 extends from the second sump 104 to the bulk scavenge conduit 152. A fourth branch 160 extends from the third sump 106 to the bulk scavenge conduit 152. As shown in the illustrated example of FIG. 2, the branches 154, 156, 158, 160 are in parallel with each other.

Further, the system 100 includes first, second, third, and fourth scavenge pumps 124, 146, 148, 150. Specifically, the first scavenge pump 124 is fluidly coupled in series with the fourth branch 160 and is configured to pump lubricant from the third sump 106 to the reservoir 110. The second scavenge pump 146 is fluidly coupled in series with the third branch 158 and is configured to pump lubricant from the second sump 104 to the reservoir 110. Further, the third scavenge pump 148 is fluidly coupled in series with the second branch 156 and is configured to pump lubricant from the first sump 102 to the reservoir 110. Lastly, the fourth scavenge pump 150 is fluidly coupled in series with the first branch 154 and is configured to pump lubricant from the AGB 108 to the reservoir 110. After passing through the scavenge pumps 124, 146, 148, 150, the scavenged lubricant in the branches 154, 156, 158, 160 is combined into the bulk scavenge conduit 152. In one example, the scavenge pumps 124, 146, 148, 150 are driven (e.g., as indicated by a shaft 126) with the supply pump 114 via the AGB 108. In other examples, the scavenge pumps 124, 146, 148, 150 can be driven by an external power source, by an internal motor of the scavenge pump 124, etc.

Additionally, other component(s) can be operatively coupled with the scavenge circuit 122. In some examples, the lubricant within the scavenge circuit 122 can flow through one or more actuators for guide vanes and/or splitter lips, various filters/screens, and/or a deaerator.

In some examples, one or more components of the system 100 can be vented. In the illustrated example of FIG. 2, the system 100 includes a vent conduit 128 extending from the AGB 108 to the reservoir 110. The vent conduit 128 can convey vapors present within the reservoir 110 to the AGB 108. In some examples, other components of the system 100, such as the sumps 102, 104, 106, can be vented to the AGB 108. In these examples, the AGB 108 can be vented to the exhaust section 38 (FIG. 1) of the gas turbine engine 10. Further, in the illustrated example of FIG. 2, the vent conduit 128 includes a check valve 129 configured to prevent lubricant present within the AGB 108 from flowing through the vent conduit 128 to the reservoir 110.

In the example of FIG. 2, the system 100 includes a valve 130 and a bypass conduit 132. The valve 130 is fluidly coupled in series with the supply conduit 112 and scavenge circuit 122. As shown in FIG. 2, the valve 130 is fluidly coupled to the supply conduit 112 downstream of the supply pumps 114. Furthermore, the valve 130 is coupled to a downstream end of the bulk scavenge conduit 152. The scavenge circuit 122 includes a return conduit 162 extending from the valve 130 to the reservoir 110. The bypass conduit 132 extends from the valve 130 to a location 134 on the scavenge circuit 122 downstream of the deicing circuit 116. The location 134 can be upstream of the lubricant filter 118 and the lubricant cooler 120, and the sumps 102, 104, 106 and the AGB 108. In circumstances when the supply pump 114 is unable to pump lubricant from the reservoir 110 into the supply conduit 112, the valve 130 and the bypass conduit 132 allow the lubricant flowing through the scavenge circuit 122 to bypass the reservoir 110 and reenter the supply conduit 112 downstream of the deicing circuit 116. Additionally, a check valve 136 is fluidly coupled to the supply conduit 112 between the deicing circuit 116 and the location 134. The check valve 136 is configured to prevent the lubricant entering the supply conduit 112 from the bypass conduit 132 from flowing back into the deicing circuit 116.

The valve 130 is configured to direct the lubricant flowing through the scavenge circuit 122 into the reservoir 110 when supply of the lubricant is not interrupted and into the bypass conduit 132 when supply of the lubricant is interrupted (e.g., damage by ballistics/projectiles, performance of an aerial maneuver, etc.). In some examples, the valve 130 is configured as a two-position/three-way valve. The valve 130 includes a supply position 138 (e.g., a first position, a normal position, etc.) at which the lubricant in the supply conduit 112 flows through the valve 130 to provide lubrication to the engine 10 and the lubricant in the scavenge circuit 122 flows to the reservoir 110. When the valve 130 is at the supply position 138, the lubricant in the scavenge circuit 122 (e.g., the bulk scavenge conduit 152) is blocked from flowing into the bypass conduit 132. Further, the valve 130 includes a bypass position 140 (e.g., a second position, etc.) at which the lubricant in the scavenge circuit 122 (e.g., the bulk scavenge conduit 152) flows into the bypass conduit 132. When the valve 130 is at the bypass position 140, the lubricant in the scavenge circuit 122 (e.g., the bulk scavenge conduit 152) is blocked from flowing to the reservoir 110.

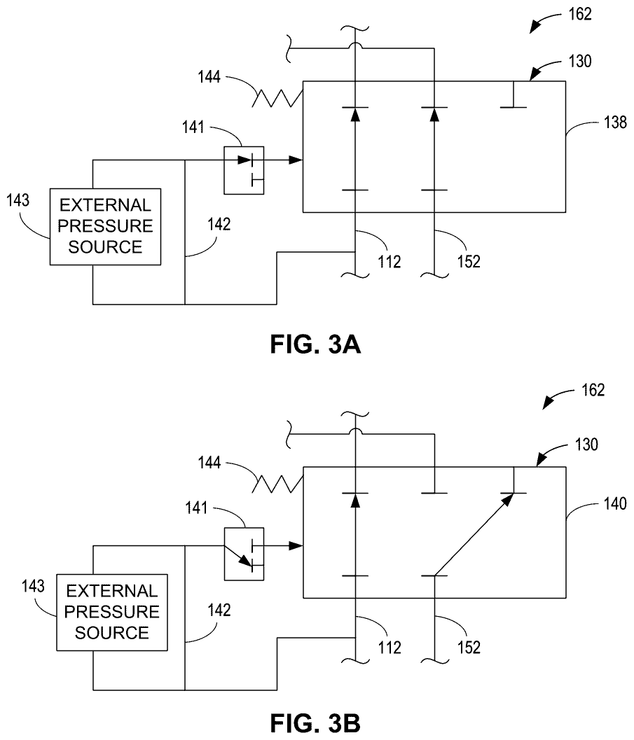

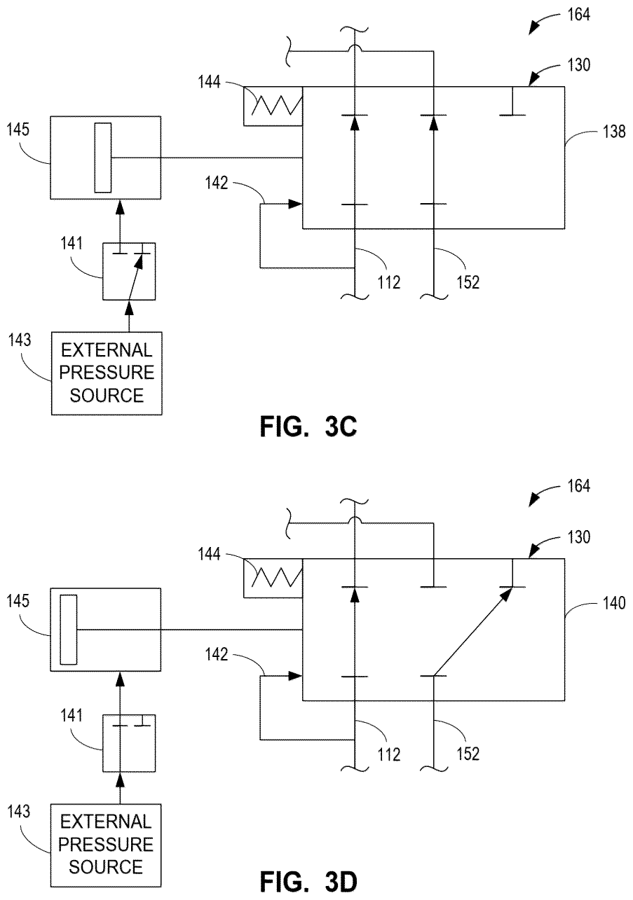

In some examples, the valve 130 is configured as a fluid-activated spool valve. In these examples, a fluid passage 142 extends from the supply conduit 112 to the valve 130 such that the lubricant within the fluid passage 142 acts or otherwise exerts a force on the valve 130. While shown as separate from the valve 130 in FIG. 2, the fluid passage 142 can be included within the valve 130. Further, the valve 130 includes a biasing element 144 (e.g., a spring) configured to bias the valve 130 towards its bypass position 140. In the bypass position 140, the lubricant is pumped from the reservoir 110 through the supply conduit 112 and acts on a spool (included in a callout 164 and described in greater detail in connection FIGS. 3A and 3B) to overcome the bias of the biasing element 144 and move the valve 130 to the supply position 138. However, when the flow of lubricant from the reservoir 110 is halted, no lubricant acts on the spool. In such instances, the biasing element 144 moves the valve 130 to the bypass position 140. In another example, the biasing element 144 is configured to bias the valve 130 towards the supply position 138. In this example, the lubricant flowing through both the supply conduit 112 and the scavenge circuit 122 acts on the spool. When the flow of lubricant from the reservoir 110 is halted, the lubricant flowing through the scavenge circuit 122 (e.g., the bulk scavenge conduit 152) is not counteracted by the lubricant flowing through the supply conduit 112. In such instances, the lubricant flowing through the scavenge circuit 122 (e.g., the bulk scavenge conduit 152) overcomes the biasing element 144 such that the valve 130 is moved to its bypass position 140. In other examples, the valve 130 can be configured to operate in any suitable manner to actuate between the supply position 138 and the bypass position 140.

In some examples, the lubricant flowing through the scavenge circuit 122 does not exert enough pressure to move the valve 130 from the supply position 138 to the bypass position 140. In these examples, the lubricant in the scavenge circuit 122 does not overcome the biasing element 144. To overcome the biasing element 144, an external pressure source 143 (e.g., an external pump, etc.), fluidly connected with the valve 130 to actuate the valve 130 to the bypass position 140 (e.g., the external pressure source 143 can provide a pressure to an assisting piston (shown in FIGS. 3A-3D) to actuate the valve 130). The pressure provided by the external pressure source 143 can be sufficient to actuate the valve to the bypass position 140 without pressure from lubricant in the scavenge circuit 122, or it can provide pressure sufficient to partially actuate the valve to the bypass position 140. The external pressure source 143 can be located in an area of the turbine engine 10 that is not damaged upon damage to the reservoir 110 (e.g., a sump buffer, vent air, etc.). In some examples, the external pressure source 143 provides constant pressure to actuate the valve 130 from the supply position 138 to the bypass position 140. In other examples, the external pressure source 143 is triggered to initiate pressure on the valve 130 after the discharge pressure from the supply pump 114 of the reservoir 110 drops below a threshold value. Further, the external pressure source 143 can cease to provide pressure after the discharge pressure from the supply pump 114 of the reservoir 110 exceeds the threshold value. The threshold value can depend on the design of the engine. In some examples, the threshold value is less than any pressure that occurs during normal engine operation.

During normal operation of the system 100, the valve 130 directs the lubricant flowing through the scavenge circuit 122 to the reservoir 110. In normal operation, the supply pump 114 pumps the lubricant from the reservoir 110 through the supply conduit 112 to lubricate the sumps 102, 104, 106 and the AGB 108. When the lubricant flows through the supply conduit 112 and the scavenge circuit 122, the valve 130 is in the supply position 138. When the valve 130 is in the supply position 138, the lubricant flowing through the scavenge circuit 122 from the sumps 102, 104, 106 and the AGB 108 is directed to the reservoir 110. For example, the valve 130 directs the lubricant within the bulk scavenge conduit 152 into the return conduit 162 for delivery to the reservoir 110. The lubricant returned to the reservoir 110 is subsequently recirculated through the system 100.

During bypass operation of the system 100, the valve 130 is in the bypass position 140 and the bypass conduit 132 allows the lubricant within the scavenge circuit 122 to bypass the reservoir 110 and reenter the supply conduit 112 downstream of the deicing circuit 116. In some instances, the supply pump 114 may be unable to pump lubricant from the reservoir 110 through the supply conduit 112. For example, the reservoir 110 and/or the deicing circuit 116 may become damaged during operation (e.g., due to ballistics/projectiles, etc.) and leak lubricant. Such a leak may drain the system 100 of lubricant, which can result in damage to the sumps 102, 104, 106, and the AGB 108. Additionally, certain aerial maneuvers may cause the lubricant to flow to one side of the reservoir 110. In such instances, the supply pump 114 is unable to continuously supply lubricant to the sumps 102, 104, 106, and the AGB 108.

The lack of lubricant flow through the supply conduit 112 (and, more specifically, the valve 130) causes the valve 130 to move to the bypass position 140. When at the bypass position 140, the valve 130 directs the lubricant flowing through the scavenge circuit 122 into the bypass conduit 132. For example, the valve 130 directs the lubricant within the bulk scavenge conduit 152 into the bypass conduit 132. The lubricant flows through the bypass conduit 132 and bypasses the reservoir 110 before reentering the supply conduit 112 at the location 134 downstream of the deicing circuit 116. In some examples, the lubricant flows through the lubricant filter 118 and the lubricant cooler 120 before reentering the supply conduit 112.

The check valve 136 prevents the lubricant from flowing backwards from the location 134 into the deicing circuit 116. In some examples, the check valve 129 prevents lubricant within the AGB 108 from flowing to the reservoir 110. In these examples, when the supply pump 114 is unable to supply lubricant to the one or more components, the system 100 redirects lubricant from the scavenge circuit 122 back to the supply conduit 112 for subsequent delivery to the components.

Accordingly, unlike conventional lubrication systems, the disclosed system 100 allows lubricant to be continuously supplied to the components when the reservoir 110 and/or the deicing circuit 116 become damaged. Further, the system 100 provides an external pressure source 143 to actuate the valve 130 in circumstances where the pressure from the lubricant in the scavenge circuit 122 is insufficient to actuate the valve 130 to the bypass position.

FIGS. 3A-3D are expanded views of the callout 164 of FIG. 2. FIG. 3A is an expanded view of the valve 130 in the supply position 138 at which the valve 130 is controlled (e.g., the external pressure source 143 provides pressure constantly) by the pressure from the supply conduit 112, the bulk scavenge conduit 152, and the external pressure source 143. FIG. 3B is an expanded view of the valve 130 in the bypass position 140 at which the valve 130 is controlled (e.g., the external pressure source 143 provides pressure constantly) by the pressure from the supply conduit 112, the bulk scavenge conduit 152, and the external pressure source 143. FIG. 3C is an expanded view of the valve 130 in the supply position 138 at which the valve 130 is controlled (e.g., the external pressure source 143 provides pressure based on signals from control logic) by a pressure from the supply conduit 112 and the bulk scavenge conduit 152 (e.g., the external pressure source 143 is prevented from reaching the assisting piston 145based on signals from control logic).

FIG. 3D is an expanded view of the valve 130 in the bypass position 140 at which the valve 130 is controlled (e.g., the external pressure source 143 provides pressure based on signals from control logic) by the pressure from the supply conduit 112 and the bulk scavenge conduit 152 augmented by the external pressure source 143 through a spool 141 to counteract the biasing element 144 (e.g., the external pressure source 143 provides pressure to the assisting piston 145 to overcome the biasing element 144 based on signals from control logic).

FIG. 3A illustrates an example where the valve 130 is in the supply position 138. In the example of FIG. 3A, the external pressure source 143 is fluidly connected directly to the biasing element 144 and the valve 130. In this example, the external pressure source 143 constantly provides pressure to the biasing element 144. The external pressure source 143 has not actuated the valve 130 from the supply position 138 to the bypass position 140 (FIG. 3B). Therefore, the external pressure source 143 does not provide sufficient pressure to overcome the biasing element 144 to actuate the valve 130 from the supply position 138 to the bypass position 140. In other examples, the external pressure source 143 can provide sufficient pressure to overcome the prevailing load balance to actuate the valve 130 from the supply position 138 to the bypass position 140.

FIG. 3B illustrates an example similar to FIG. 3A where the external pressure source 143 is fluidly connected to the biasing element 144 and the valve 130. However, in the example of FIG. 3B, the external pressure source 143 provides sufficient pressure to overcome the biasing element 144 (e.g., the prevailing load balance) to actuate the valve 130 from the supply position 138 (FIG. 3A) to the bypass position 140.

FIG. 3C illustrates a position of a spool 141 (described in connection with FIG. 2) when there is sufficient discharge pressure from the supply pump 114 (FIG. 2) to pump the lubricant to the one or more components of the engine. In this example, the spool 141 is fluidly coupled between the external pressure source 143, the assisting piston 145, and the valve 130. Accordingly, pressure from the lubricant within the supply conduit 112 and bulk scavenge conduit 152 acts on the valve 130. The prevailing load balance that results from the biasing element 144 causes the pressure from the supply conduit 112 and the bulk scavenge conduit 152 to maintain the valve 130 in the supply position 138. In some examples, the prevailing load balance that results from the biasing element 144 maintains the valve towards the bypass position 140 (FIG. 3D). In these examples, the pressure from the supply conduit 112 and the bulk scavenge conduit 152 maintains the valve 130 in the supply position 138. In a disconnected position, the spool 141 does not trigger the external pressure source 143 to actuate the valve 130 from the supply position 138 to the bypass position 140 (shown in FIG. 3B). As used herein, the disconnected position of the spool 141 does not allow pressure from the external pressure source 143 to overcome the biasing element 144. In other examples, the external pressure source 143 provides pressure after a threshold change in pressure in the fluid passage 142. In these examples, the external pressure source 143 can provide pressure after a threshold drop in pressure in the fluid passage 142.

FIG. 3D illustrates the spool 141 when there is not sufficient discharge pressure from the supply pump 114 (FIG. 2) to pump the lubricant to the one or more components of the engine. When the flow of lubricant from the reservoir 110 is halted, the pressure from the fluid passage 142 is halted and/or diminished. The spool 141 switches to the connected position to allow the assisting piston 145 to overcome the biasing element 144. Therefore, pressure in the fluid passage 142 switches the spool 141 into the disconnected position (as shown above in FIG. 3A), but lack of pressure from the fluid passage 142 switches the spool 141 into the connected position. In some examples, the position of the spool 141 is determined based on a signal from control logic and a sensor to determine pressure changes. In the example of FIGS. 3A-3D, the biasing element 144 biases the valve 130 to the bypass position 140 so that, in the absence of the pressure and/or a threshold pressure from the fluid passage 142, the valve 130 is in the bypass position 140. In some examples, the biasing element 144 biases the valve 130 to the supply position 138 (e.g., supplied pressure moves the valve 130 from the supply position 138 to the bypass position 140). In these examples, in the absence of pressure and/or a threshold pressure from the fluid passage 142, the valve 130 is in the supply position 138. In some examples, the biasing element 144 does not fully actuate the valve 130 to the bypass position 140 (e.g., insufficient pressure to fully actuate to the bypass position 140, etc.). In these examples, the external pressure source 143 can provide pressure from an area of the engine unaffected by the halted lubricant (e.g., an undamaged area and/or area resistant to changes from aerial maneuvers, etc.) to fully actuate the valve to the bypass position 140. In some examples, the spool 141 switching to the connected position triggers the external pressure source 143 to provide pressure to overcome the biasing element 144. The external pressure source 143 ensures that in circumstances where lubricant flow is halted the bypass position 140 is fully opened to allow consistent lubricant flow to the one or more components of the engine.

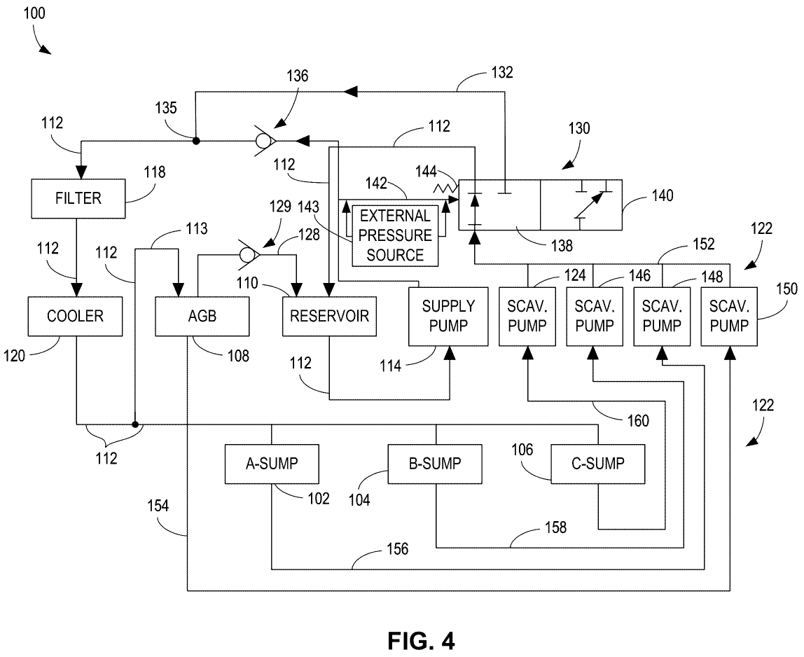

FIG. 4 is a schematic view of another example of the system 100 for lubricating components of a gas turbine engine. Similar to the example shown in FIG. 2, the system 100 shown in FIG. 4 includes the reservoir 110; the supply circuit or conduit 112; the supply pump 114; the scavenge circuit 122; the scavenge pumps 124, 146, 148, 150; the valve 130; and the external pressure source 143. However, unlike the example in FIG. 2, the system of FIG. 4 does not include the deicing circuit 116. Instead, the bypass conduit 132 extends from the valve 130 to a location 135 on the supply conduit 112 downstream of the supply pump 114 and upstream of the lubricant filter 118. Accordingly, the check valve 136 is positioned between the location 135 and the supply pump 114 to prevent the lubricant entering the supply conduit 112 from the bypass conduit 132 from flowing back into the reservoir 110. In operation, when the lubricant is supplied from the reservoir 110 to the sumps 102, 104, 106 and the AGB 108, the valve 130 directs the lubricant flowing through the scavenge circuit 122 into the reservoir 110. Conversely, when the supply of the lubricant from the reservoir 110 to the sumps 102, 104, 106 and the AGB 108 is halted, the valve 130 directs the lubricant flowing through the scavenge circuit 122 into the bypass conduit 132.

Additionally, unlike the example of FIG. 2, in the system of FIG. 4, the valve 130 is positioned such that the valve 130 is unable to control the flow of the lubricant through the supply conduit 112. Instead, the valve 130 is fluidly actuated by the flow of the lubricant through the supply conduit 112. Specifically, the fluid passage 142 extends from the supply conduit 112 to the valve 130 such that the fluid within the fluid passage 142 actuates the valve 130. Further, the fluid passage 142 is fluidly coupled to the supply conduit 112 downstream of the supply pump 114. In the illustrated example of FIG. 4, the external pressure source 143 is fluidly connected with the biasing element 144. As shown in FIGS. 3A-3D, the external pressure source 143 can be, additionally or alternatively, fluidly connected with the assisting piston 145. The external pressure source 143 can provide an external pressure to the valve 130 to actuate and/or contribute the actuating the valve 130 in tandem with the pressure provided in the fluid passage 142. The external pressure source 143 can constantly provide pressure or be triggered to provide pressure to actuate the valve 130 based on the threshold value, as described in connection with FIG. 2.

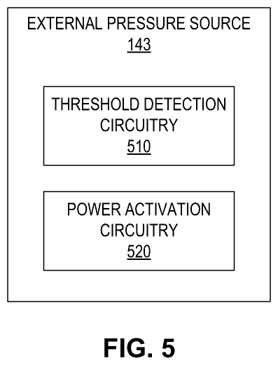

FIG. 5 is a block diagram of an example implementation of the external pressure source 143 of FIG. 2 to provide pressure to actuate the valve 130 and/or contribute to actuating the valve 130. The external pressure source 143 of FIG. 5 includes example threshold detection circuitry 510 and example power activation circuitry 520. The external pressure source 143 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the external pressure source 143 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The threshold detection circuitry 510 determines a threshold charge in discharge pressure of the supply pump 114. In some examples, the threshold detection circuitry 510 can detect the discharge pressure via a sensor and/or another sensing device near the supply pump 114. The threshold detection circuitry 510 determines whether a change has occurred in discharge pressure of the supply pump 114 to warrant activation of the external pressure source 143. In some examples, the threshold detection circuitry 510 monitors for a change in pressure from a first pressure to a second pressure, where the first pressure is equal to or greater than the second pressure by a predetermined amount. The predetermined amount can correspond to a discharge pressure required to lubricate the one or more components of the gas turbine engine through the valve 130. If the threshold detection circuitry 510 senses a threshold change in pressure, the supply pump 114 is not outputting a discharge pressure sufficient to lubricate one or more components of the gas turbine engine.

If the threshold detection circuitry 510 does not sense a threshold change in pressure (e.g., the difference between the first pressure and the second pressure is not equal to or greater than the predetermined amount), then the threshold detection circuitry 510 continues to monitor the discharge pressure of the supply pump 114.

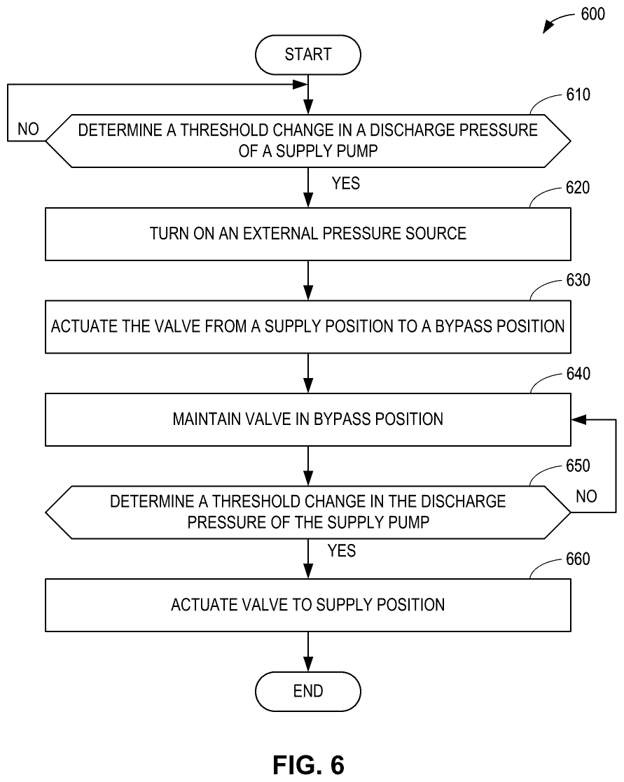

Further, the threshold detection circuitry 510 can determine, after activation of the external pressure source 143, whether a threshold change in the discharge pressure of the supply pump 114 has occurred. In these examples, the threshold detection circuitry 510 determines whether a threshold change in pressure occurs that indicates that pressure has returned to a pressure sufficient to lubricate the one or more components of the gas turbine engine (e.g., a first pressure is less than the second pressure, and the difference between the first pressure and the second pressure is greater than a predetermined amount). In some examples, the threshold detection circuitry 510 is instantiated by programmable circuitry executing threshold detection instructions and/or configured to perform operations such as those represented by the flowchart of FIG. 6 (blocks 610 and 650).

The power activation circuitry 520 activates a pressure outlet of the external pressure source 143 based on receiving from the threshold detection circuitry 510 a signal that a threshold change in discharge pressure of the supply pump 114 has occurred. In other words, the external pressure source 143 provides pressure to the valve 130 to actuate the valve 130 from a supply position to a bypass position in response to a determination that the discharge pressure of the supply pump 114 has dropped. In the bypass position, lubricant is directed away from a damaged and/or temporarily compromised part of the system 100 and can lubricate other components. The external pressure source 143 maintains the valve in the bypass position by providing the pressure to the valve 130. In some examples, the external pressure source 143 is a sole source of pressure to the valve 130 or the external pressure source 143 provides pressure in tandem with another pressure of the system 100.

After determination that the threshold change in pressure is sufficient to provide lubricant to the system 100, the power activation circuitry 520 can turn off the external power source 143 to allow the valve 130 to actuate to the supply position from the bypass position. In some examples, the power activation circuitry 520 is instantiated by programmable circuitry executing threshold detection instructions and/or configured to perform operations such as those represented by the flowchart of FIG. 6 (blocks 620-640 and 660).

In some examples, the external pressure source 143 includes means for determining a threshold change in discharge pressure of a supply pump and means for activating an external pressure source. For example, the means for determining and activating may be implemented by threshold detection circuitry 510 and power activation circuitry 520, respectively. Additionally or alternatively, the threshold detection circuitry 510 and the power activation circuitry 520 may be instantiated by any other combination of hardware, software, and/or firmware. For example, the threshold detection circuitry 510 and the power activation circuitry 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the external pressure source 143 of FIG. 2 is illustrated in FIG. 5, one or more of the elements, processes, and/or devices illustrated in FIG. 5 may be combined, divided, re-arranged, omitted, eliminated, and/or implemented in any other way. Further, the example threshold detection circuitry 510, the example power activation circuitry 520, and/or, more generally, the example external pressure source 143 of FIG. 5, may be implemented by hardware alone or by hardware in combination with software and/or firmware. Thus, for example, any of the example threshold detection circuitry 510, the example power activation circuitry 520, and/or, more generally, the example external pressure source 143, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example external pressure source 143 of FIG. 5 may include one or more elements, processes, and/or devices in addition to, or instead of, those illustrated in FIG. 5, and/or may include more than one of any or all of the illustrated elements, processes and devices.

A flowchart representative of example machine readable instructions, which may be executed by programmable circuitry to implement and/or instantiate the external pressure source 143 of FIG. 5 and/or representative of example operations which may be performed by programmable circuitry to implement and/or instantiate the external pressure source 143 of FIG. 5, are shown in FIG. 6. The machine readable instructions may be one or more executable programs or portion(s) of one or more executable programs for execution by programmable circuitry. In some examples, the machine readable instructions cause an operation, a task, etc., to be carried out and/or performed in an automated manner in the real world. As used herein, “automated” means without human involvement.

FIG. 6 is a flowchart of an example method 600 of operation of the apparatus of FIGS. 2-4. The method 600 of FIG. 6 begins with determining a threshold change in a discharge pressure of the supply pump 114 (block 610). In some examples, a sensor may be arranged in fluid communication with a supply conduit 112 from the supply pump 114 and/or at another position in the system 100 of FIGS. 2-4. In these examples, the sensor can determine whether the discharge pressure from the supply pump 114 has changed (e.g., dropped) below a threshold. The threshold pressure corresponds to a discharge pressure from the supply pump 114 necessary to lubricate the one or more components of the gas turbine engine through the valve 130. If the threshold change in pressure is not determined (block 610: NO), the process continues to monitor for a change in the threshold pressure.

If the threshold change in pressure is determined (block 610: YES), the external pressure source 143 actuates the valve 130 from the supply position 138 to the bypass position 140 (block 620). The external pressure source 143 provides pressure to actuate the valve 130 fully to the bypass position 140. In the bypass position 140, the system can continue to provide lubricant to the one or more components of the engine. In some examples, to actuate the valve 130 to the bypass position 140 the external pressure source 143 turns on and begins to provide pressure. In these examples, the external pressure source 143 is turned on by a processor that receives sensor readings from a sensor. In some examples, the processor can be located on the external pressure source 143 and/or is configured to communicate commands to the external pressure source 143. In other examples, the external pressure source 143 is constantly providing pressure despite changes in discharge pressure of the supply pump 114. In these examples, the external pressure source 143 is configured to produce pressure regardless of changes in the discharge pressure of the supply pump 114 (e.g., constantly produces pressure).

Further, in some examples, the biasing element 144 biases the valve 130 towards the bypass position 140, and the external pressure source 143 provides the remaining pressure to actuate the valve 130 fully to the bypass position 140. In other examples, there is not a biasing element 144 or the biasing element 144 biases the valve towards the supply position 138. In these examples, the external pressure source 143 provides pressure to fully actuate the valve 130 to the bypass position 140 and/or provides pressure to counteract the biasing element 144 and fully actuate the valve 130 to the bypass position 140.

After the valve 130 is actuated to the bypass position 140, the valve 130 is maintained in the bypass position 140 (block 630). In some examples, after the valve 130 is in the bypass position 140, the external pressure source 143 ceases providing pressure. In these examples, the biasing element 144 can bias the valve 130 to the bypass position 140. In other examples, the external pressure source 143 continues providing pressure (e.g., the pressure can be lessened to sufficiently counteract the biasing element 144, maintained at the pressure required to fully actuate the valve 130 to the bypass position 140, and/or a pressure sufficient to maintain the valve 130 in the bypass position 140).

In the bypass position 140, the process determines whether there is a threshold change in the discharge pressure of the supply pump 114 (block 640). The threshold change can include an increase in pressure sufficient to supply lubricant to the one or more components of the engine without the scavenge circuit. In other examples, the threshold change is sufficient pressure to actuate the valve 130 from the bypass position 140 to the supply position 138. If a threshold change in discharge pressure of the supply pump 114 is not determined (block 640: NO), the process continues to monitor for the threshold change.

After the threshold change in the discharge pressure of the supply pump 114 is determined (block 640: YES), the valve 130 actuates to the supply position 138 (block 650). In some examples, upon determination of the threshold change, the external pressure source 143 may shut off. In other examples, the external pressure source 143 can continue to provide pressure.

In these examples, the threshold change must produce pressure sufficient to counteract the external pressure source 143 to actuate the valve 130 to the supply position 138. After actuation of the valve 130 to the supply position 138 (block 660), the method 600 ends.

Example methods, apparatus, systems, and articles of manufacture to lubricate components of a gas turbine engine via an external pressure source are disclosed herein. Further examples and combinations thereof are provided by the subject matter of the following clauses.

An example system for lubricating a gas turbine engine includes a reservoir configured to store a lubricant, a supply pump configured to pump the lubricant from the reservoir to a component of the gas turbine engine via a supply conduit, a scavenge pump configured to pump the lubricant from the component, and a valve fluidly coupled with the scavenge pump, the valve to control a flow of the lubricant to the reservoir; and an external pressure source coupled with the valve, the external pressure source to provide a pressure to actuate the valve from a supply position to a bypass position, wherein in the bypass position the valve fluidly couples the lubricant flowing through the scavenge pump into a bypass conduit, the bypass conduit extending from the valve to a location downstream of the supply pump.

In the example system of any preceding clause, the external pressure source provides the pressure to actuate the valve to the bypass position when a discharge pressure from the supply pump to the component is below a threshold value.

In the example system of any preceding clause, in response to a discharge pressure from the supply pump exceeding a threshold value, the valve actuates to the supply position.

In the example system of any preceding clause, further including a fluid passage extending from the supply conduit between the supply pump and the valve, wherein the lubricant flows within the fluid passage, and wherein the lubricant within the fluid passage partially actuates the valve to the bypass position.

In the example system of any preceding clause, wherein the external pressure source supplements the pressure supplied by the lubricant within the fluid passage to fully actuate the valve to the bypass position.

In the example system of any preceding clause, wherein the bypass conduit extends from the valve to a location on the supply conduit downstream of the supply pump.

In the example system of any preceding clause, further including a lubricant filter, the lubricant filter to filter the lubricant from the supply conduit before supplying the lubricant to the component.

In the example system of any preceding clause, further including a lubricant cooler fluidly coupled to the supply conduit downstream of the location on the supply conduit downstream of the supply pump, wherein after filtering, the lubricant cooler cools the lubricant before supplying the lubricant to the component.

In the example system of any preceding clause, further including a check valve fluidly coupled to the supply conduit between the supply pump and the location where the bypass conduit fluidly couples to the supply conduit.

In the example system of any preceding clause, wherein the check valve is configured to prevent the lubricant entering the supply pump from the bypass conduit from flowing back into the reservoir.

In the example system of any preceding clause, further including a deicing circuit coupled to the supply conduit, wherein the supply pump pumps the lubricant from the reservoir through the deicing circuit to the component of the gas turbine engine.

In the example system of any preceding clause, further including a first sump, a second sump, and a third sump, wherein the first sump, the second sump, and the third sump direct the lubricant from the component to the scavenge pump.

In the example system of any preceding clause, further including a scavenge circuit, the scavenge circuit to include at least one scavenge conduit and the scavenge pump to direct the lubricant from the component to the reservoir.

In the example system of any preceding clause, further including a biasing element, the biasing element to bias the valve to the supply position.

In the example system of any preceding clause, the external pressure source to provide a pressure to overcome the biasing element to actuate the valve from the supply position to the bypass position.

In the example system of any preceding clause, wherein the biasing element is to bias the valve to the bypass position.

In the example system of any preceding clause, the external pressure source to provide the pressure to overcome the biasing element to actuate the valve from the bypass position to the supply position.

In the example system of any preceding clause, further including an assisting piston, the assisting piston to receive pressure from the external pressure source and provide pressure to overcome the biasing element.

An example gas turbine engine, including a compressor section, a combustion section, a turbine section, one or more components operatively coupled with at least one of the compressor section, the combustion section, or the turbine section, a reservoir configured to store a lubricant, a supply pump configured to pump the lubricant from the reservoir to a component via a supply conduit, a scavenge pump configured to pump the lubricant from the component, and a valve fluidly coupled with the scavenge pump, the valve to control a flow of lubricant to the reservoir; and, an external pressure source coupled with the valve, the external pressure source to provide a pressure to actuate the valve from a supply position to a bypass position, wherein in the bypass position the valve fluidly couples lubricant flowing through the scavenge pump into a bypass conduit, the bypass conduit extending from the valve to a location downstream of the supply pump.

In the example gas turbine engine of any preceding clause, wherein the external pressure source provides the pressure to actuate the valve to the bypass position when a discharge pressure from the supply pump to the component is below a threshold value.

In the example gas turbine engine of any preceding clause, wherein, in response to a discharge pressure from the supply pump exceeding a threshold value, the valve actuates to the supply position.

In the example gas turbine engine of any preceding clause, further including a fluid passage extending from the supply conduit between the supply pump and the valve, wherein the lubricant flows within the fluid passage, and wherein the lubricant within the fluid passage partially actuates the valve to the bypass position.

In the example gas turbine engine of any preceding clause, wherein the external pressure source supplements the pressure supplied by the lubricant within the fluid passage to fully actuate the valve to the bypass position.

In the example gas turbine engine of any preceding clause, wherein the bypass conduit extends from the valve to a location on the supply conduit downstream of the supply pump.

In the example gas turbine engine of any preceding clause, further including a lubricant filter, the lubricant filter to filter the lubricant from the supply conduit before supplying the lubricant to the component.

In the example gas turbine engine of any preceding clause, further including a lubricant cooler fluidly coupled to the supply conduit downstream of the location on the supply conduit downstream of the supply pump, wherein after filtering, the lubricant cooler cools the lubricant before supplying the lubricant to the component.

In the example gas turbine engine of any preceding clause, further including a check valve fluidly coupled to the supply conduit between the supply pump and the location where the bypass conduit fluidly couples to the supply conduit.

In the example gas turbine engine of any preceding clause, wherein the check valve is configured to prevent the lubricant entering the supply pump from the bypass conduit from flowing back into the reservoir.

In the example gas turbine engine of any preceding clause, further including a deicing circuit coupled to the supply conduit, wherein the supply pump pumps the lubricant from the reservoir through the deicing circuit to the component of the gas turbine engine.

In the example gas turbine engine of any preceding clause, further including a first sump, a second sump, and a third sump, wherein the first sump, the second sump, and the third sump direct the lubricant from the component to the scavenge pump.

In the example gas turbine engine of any preceding clause, further including a scavenge circuit, the scavenge circuit to include at least one scavenge conduit and the scavenge pump to direct the lubricant from the component to the reservoir.

In the example gas turbine engine of any preceding clause, further including a biasing element, the biasing element to bias the valve to the supply position.

In the example gas turbine engine of any preceding clause, the external pressure source to provide a pressure to overcome the biasing element to actuate the valve from the supply position to the bypass position.

In the example gas turbine engine of any preceding clause, wherein the biasing element is to bias the valve to the bypass position.

In the example gas turbine engine of any preceding clause, the external pressure source to provide the pressure to overcome the biasing element to actuate the valve from the bypass position to the supply position.

In the example gas turbine engine of any preceding clause, further including an assisting piston, the assisting piston to receive pressure from the external pressure source and provide pressure to overcome the biasing element.

An example method for lubricating a gas turbine engine, including determining a threshold change in a discharge pressure of a lubricant from a supply pump, the supply pump configured to pump the lubricant from a reservoir to a component of the gas turbine engine via a supply conduit, and, in response to a determination of the threshold change in the discharge pressure of the supply pump, actuate a valve, via an external pressure source, from a supply position to a bypass position, wherein the valve is fluidly coupled with a scavenge pump to pump the lubricant from the component and in the bypass position the valve fluidly couples the lubricant flowing through the scavenge pump into a bypass conduit, the bypass conduit extending from the valve to a location downstream of the supply pump.

In the example method of any preceding clause, wherein the threshold change in the discharge pressure of the lubricant from the supply pump is a threshold drop in the discharge pressure.

In the example method of any preceding clause, wherein, after determining the threshold drop in the discharge pressure, actuating the valve, via the external pressure source, to the bypass position.

In the example method of any preceding clause, wherein the threshold change in the discharge pressure of the lubricant from the supply pump is a threshold increase in the discharge pressure.

In the example method of any preceding clause, wherein, after determining the threshold increase in the discharge pressure, actuating the valve, via the external pressure source, to a supply position.

In the example method of any preceding clause, further including a fluid passage extending from the supply conduit between the supply pump and the valve, wherein the lubricant within the fluid passage partially actuates the valve to the bypass position.

In the example method of any preceding clause, wherein the external pressure source supplements the pressure supplied by the lubricant within the fluid passage to fully actuate the valve to the bypass position.

In the example method of any preceding clause, wherein the bypass conduit extends from the valve to a location on the supply conduit downstream of the supply pump.

In the example method of any preceding clause, further including filtering the lubricant, via a lubricant filter, from the supply conduit before supplying the lubricant to the component.

In the method of any preceding clause, further including, after filtering, cooling the lubricant, via a lubricant cooler fluidly coupled to the supply conduit downstream of the location on the supply conduit downstream of the supply pump, before supplying the lubricant to the component.

In the example method of any preceding clause, further including a check valve fluidly coupled to the supply conduit between the supply pump and the location where the bypass conduit fluidly couples to the supply conduit.

In the example method of any preceding clause, wherein the check valve is configured to prevent the lubricant entering the supply pump from the bypass conduit from flowing back into the reservoir.

In the example method of any preceding clause, further including a deicing circuit coupled to the supply conduit, wherein the supply pump pumps the lubricant from the reservoir through the deicing circuit to the component of the gas turbine engine.

In the example method of any preceding clause, further including a first sump, a second sump, and a third sump, wherein the first sump, the second sump, and the third sump direct the lubricant from the component to the scavenge pump.

In the example method of any preceding clause, further including a scavenge circuit, the scavenge circuit to include at least one scavenge conduit and the scavenge pump to direct the lubricant from the component to the reservoir.

In the example method of any preceding clause, further including a biasing element, the biasing element to bias the valve to the supply position.

In the example method of any preceding clause, the external pressure source to provide a pressure to overcome the biasing element to actuate the valve from the supply position to the bypass position.

In the example method of any preceding clause, wherein the biasing element is to bias the valve to the bypass position.

In the example method of any preceding clause, the external pressure source to provide the pressure to overcome the biasing element to actuate the valve from the bypass position to the supply position.

In the example method of any preceding clause, further including an assisting piston, the assisting piston to receive pressure from the external pressure source and provide pressure to overcome the biasing element.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system for lubricating a gas turbine engine, the system comprising:
a reservoir to store a lubricant;
a supply pump to pump the lubricant from the reservoir to a component of the gas turbine engine via a supply conduit;
a scavenge pump to pump the lubricant from the component; and
a valve fluidly coupled with the scavenge pump, the valve to control a flow of the lubricant to the reservoir; and
an external pressure source coupled with the valve, the external pressure source to provide a pressure to actuate the valve from a supply position to a bypass position, wherein in the bypass position the valve fluidly couples the lubricant flowing through the scavenge pump into a bypass conduit, the bypass conduit extending from the valve to a location downstream of the supply pump.

2. The system of claim 1, wherein the external pressure source provides the pressure to actuate the valve to the bypass position when a discharge pressure from the supply pump to the component is below a threshold value.

3. The system of claim 1, wherein, in response to a discharge pressure from the supply pump exceeding a threshold value, the valve actuates to the supply position.

4. The system of claim 1, further including a fluid passage extending from the supply conduit between the supply pump and the valve, wherein the lubricant flows within the fluid passage, and wherein the lubricant within the fluid passage partially actuates the valve to the bypass position.

5. The system of claim 4, wherein the external pressure source supplements the pressure supplied by the lubricant within the fluid passage to fully actuate the valve to the bypass position.

6. The system of claim 1, wherein the bypass conduit extends from the valve to a location on the supply conduit downstream of the supply pump.

7. The system of claim 6, further including a lubricant filter, the lubricant filter to filter the lubricant from the supply conduit before supplying the lubricant to the component.

8. The system of claim 7, further including a lubricant cooler fluidly coupled to the supply conduit downstream of the location on the supply conduit downstream of the supply pump, wherein after filtering, the lubricant cooler cools the lubricant before supplying the lubricant to the component.

9. The system of claim 1, further including a check valve fluidly coupled to the supply conduit between the supply pump and the location where the bypass conduit fluidly couples to the supply conduit.

10. The system of claim 9, wherein the check valve is configured to prevent the lubricant entering the supply pump from the bypass conduit from flowing back into the reservoir.

11. A gas turbine engine, comprising:
a compressor section;
a combustion section;
a turbine section;
one or more components operatively coupled with at least one of the compressor section, the combustion section, or the turbine section;
a reservoir configured to store a lubricant;
a supply pump configured to pump the lubricant from the reservoir to a component via a supply conduit;
a scavenge pump configured to pump the lubricant from the component; and
a valve fluidly coupled with the scavenge pump, the valve to control a flow of lubricant to the reservoir; and
an external pressure source coupled with the valve, the external pressure source to provide a pressure to actuate the valve from a supply position to a bypass position, wherein in the bypass position the valve fluidly couples lubricant flowing through the scavenge pump into a bypass conduit, the bypass conduit extending from the valve to a location downstream of the supply pump.

12. The gas turbine engine of claim 11, wherein the external pressure source provides the pressure to actuate the valve to the bypass position when a discharge pressure from the supply pump to the one or more components is below a threshold value.

13. The gas turbine engine of claim 11, wherein, in response to a discharge pressure from the supply pump exceeding a threshold value, the valve actuates to the supply position.

14. The gas turbine engine of claim 11, further including a fluid passage extending from the supply conduit between the supply pump and the valve, wherein the lubricant flows within the fluid passage, and wherein the lubricant within the fluid passage partially actuates the valve to the bypass position.

15. The gas turbine engine of claim 14, wherein the external pressure source supplements the pressure supplied by the lubricant within the fluid passage to fully actuate the valve to the bypass position.

16. The gas turbine engine of claim 11, wherein the bypass conduit extends from the valve to a location on the supply conduit downstream of the supply pump.

17. The gas turbine engine of claim 16, further including a lubricant filter, the lubricant filter to filter the lubricant from the supply conduit before supplying the lubricant to the one or more components.

18. The gas turbine engine of claim 17, further including a lubricant cooler fluidly coupled to the supply conduit downstream of the location on the supply conduit downstream of the supply pump wherein after filtering, the lubricant cooler cools the lubricant before supplying the lubricant to the component.

19. The gas turbine engine of claim 11, further including a check valve fluidly coupled to the supply conduit between the supply pump and the location where the bypass conduit fluidly couples to the supply conduit.

20. The gas turbine engine of claim 19, wherein the check valve is configured to prevent the lubricant entering the supply pump from the bypass conduit from flowing back into the reservoir.
